(19) United States
(12) Patent Application Publication
(10) Pub. No.: US 2011/0268537 A1
(43) Pub. Date: Nov. 3, 2011

(54) METHOD OF FORMING A CUSTOMIZABLE NOTEBOOK COVER

(76) Inventor: Maria L. Kalorides, Garden City, NY (US)

(21) Appl. No.: 12/986,651

(22) Filed: Jan. 7, 2011

Related U.S. Application Data
(60) Provisional application No. 61/330,096, filed on Apr. 30, 2010.

(51) Int. Cl. B42C 11/00; B29C 65/48

(52) U.S. Cl. 412/4; 156/280

(57) ABSTRACT

A method of forming a customizable notebook cover having a chipboard layer is disclosed in which a custom design is first printed on a sheet of pressure-sensitive label stock. The printed sheet of pressure-sensitive label stock is then applied to the outer side of the chipboard, which optionally may have a finished inner side and/or a finished outer side. Next, a scuff-free silk finish is applied to the outer surface of the printed sheet of pressure-sensitive label stock to produce a finished customized front notebook cover. Finally, the notebook is assembled from the finished customized front notebook cover, paper, a binding means and a rear notebook cover. The rear notebook cover is also formed from a chipboard core layer and may optionally also have a design formed thereon in the same manner as the front cover.

### CLAIM OF PRIORITY

This application claims priority to U.S. Provisional Application No. 61/330,096 entitled “Method of Forming a Customizable Notebook Cover” which was filed Apr. 30, 2010 which is hereby incorporated by reference.

### FIELD OF INVENTION

This invention relates to a method of forming a customizable notebook cover.

### BACKGROUND OF THE INVENTION

In the prior art, notebook covers have been formed from many different materials, including chipboard. However, chipboard covers, which provide better stability and rigidity to the finished notebook than other materials, have proven difficult to customize. An object of the present invention is to provide a method of forming a customizable notebook cover having a chipboard inner layer. Still further objects and advantages will become apparent from a consideration of the ensuing description and drawings.

### SUMMARY OF THE INVENTION

To achieve the foregoing objects, and in accordance with the purposes of the invention as embodied and broadly described herein, the present invention provides a method of forming a customizable notebook cover having a chipboard layer. A custom design is first printed on a sheet of pressure-sensitive label stock. The printed sheet of pressure-sensitive label stock is then applied to the outer side of the chipboard, which optionally may have finished inner side and/or a finished outer side. Next, a scuff-free silk finish is applied to the outer surface of the printed sheet of pressure-sensitive label stock to produce a finished customized front notebook cover. Finally, the notebook is assembled from the finished customized front notebook cover, inner paper sheets, a binding means and a rear notebook cover. The rear notebook cover is formed from a chipboard layer and may preferably also have a design formed thereon in the same manner as the front cover, which design may be customized or generic, or may be finished or unfinished.

### BRIEF DESCRIPTION OF THE DRAWINGS

The following detailed description, given by way of example and not intended to limit the present invention solely thereto, will best be understood in conjunction with the accompanying drawings in which:

FIG. 1A is a front view of a notebook formed in accordance with the method present invention;

FIG. 1B is a rear view of the notebook shown in FIG. 1A;

FIG. 2 is a flow chart describing the steps performed in accordance with the present invention; and

FIG. 3 is a cross-sectional view of a notebook cover formed in accordance with the method present invention.

### DETAILED DESCRIPTION OF THE PREFERRED EMBODIMENT

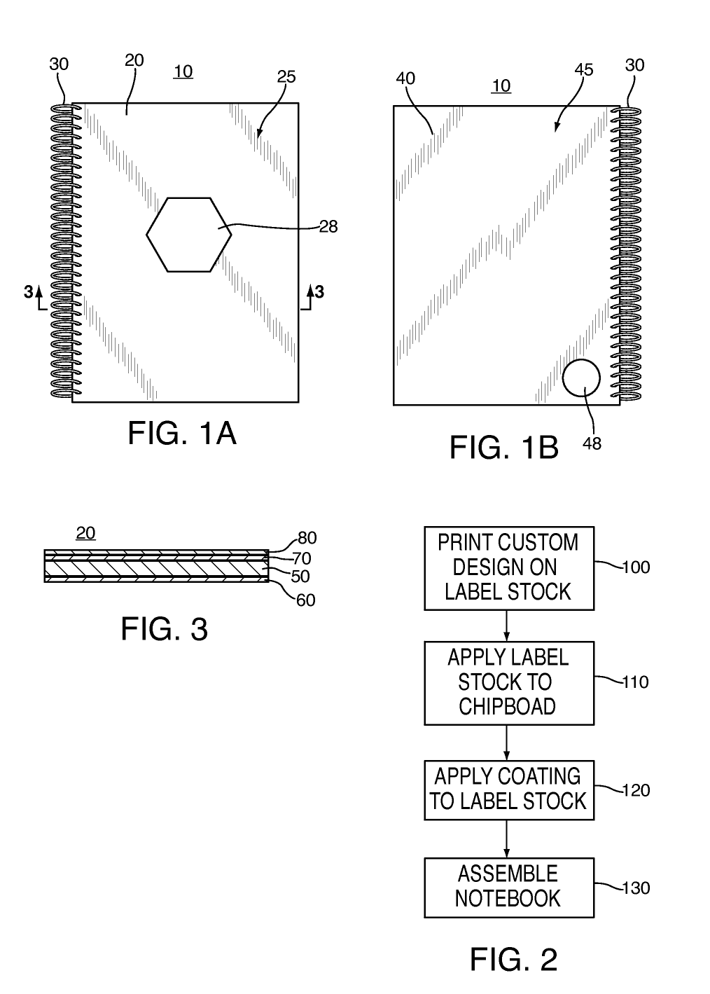

Referring now to the drawings and in particular FIGS. 1A and 1B, the notebook 10 includes a front cover 20 having a first custom design 25 and optionally personalization 28 thereon, a rear cover 40 which may also have a custom design 45 and optionally a logo 48 thereon, notepaper sandwiched between the front cover 20 and the rear cover 40 (not shown) and a binding 30 such as a spiral binding which binds the front cover 20, rear cover 40 and notepaper together. As one of ordinary skill in the art, various other types of equivalent bindings may be used for notebook 10 within the scope of the present invention. The front cover 20 has a chipboard (or equivalent) core, and is manufactured in a manner which makes it easily customizable.

As shown in the flow chart of FIG. 2, the first step 100 in manufacturing notebook 10 is to print the custom design 25 and optional personalization 28 (FIG. 1A) on a sheet of pressure-sensitive label stock. Next, the printed sheet of pressure-sensitive label stock is applied to the chipboard core at step 110. The chipboard core preferably has a finished surface on both sides thereof. Thereafter, a coating is applied to the printed sheet of pressure-sensitive label stock at step 120. This coating is preferably a scuff-free silk finish which provides longer life to the notebook cover 20 since it prevents color fading due to ink loss on the front cover, e.g., from handling thereof. Finally at step 130, the notebook is assembled from front cover 20, paper, rear cover 40 and binder 30. Rear cover 40 may be assembled according to the same process, using the same custom design (i.e., custom design 45 may be identical to custom design 25 but substituting a logo 48 for personalization 28) or a similar custom design, or may simply have a finished or unfinished surface.

As shown in the cross-sectional view of the finished notebook front cover 20 of FIG. 3, a pressure-sensitive label stock layer 70 covers chipboard core 50, and a scuff-free silk coating 80 covers the pressure-sensitive label stock layer 70. Optionally, a finished inner layer 60 may be placed on the inside of chipboard core 50. Likewise, a finished layer, not shown, may exist on the outside of core 50, i.e., between core 50 and pressure-sensitive label stock layer 70.

While the present invention has been particularly shown and described with reference to the preferred embodiments and various aspects thereof, it will be appreciated by those of ordinary skill in the art that various changes and modifications may be made without departing from the spirit and scope of the invention. It is intended that the appended claims be interpreted as including the embodiments described herein, the alternatives mentioned above, and all equivalents thereto.

What is claimed is:

1. A method of forming a customized notebook cover with a chipboard layer, comprising the steps of:
printing a custom design on a sheet of pressure sensitive label stock;
applying the printed sheet of pressure-sensitive label stock to an outer side of the chipboard layer; and
applying a finish to an outer surface of the printed sheet of pressure-sensitive label stock to produce a finished customized notebook cover.

2. The method of claim 1, wherein the finish applied to the outer surface of the printed sheet of pressure-sensitive label stock is a scuff-free silk finish.

3. The method of claim 1, further comprising the step of applying a finish to the outer side of the chipboard layer before the printed sheet of pressure-sensitive label stock is applied thereto.

4. The method of claim 1, further comprising the step of applying a finish to an inner side of the chipboard layer before the printed sheet of pressure-sensitive label stock is applied to the outer side of the chipboard layer.

5. The method of claim 1, wherein the finished customized notebook cover is a front cover.

6. The method of claim 5, wherein the custom design includes a selected custom design and personalization.

7. The method of claim 1, wherein the finished customized notebook cover is a rear cover.

8. The method of claim 7, wherein the custom design includes a selected custom design and a logo.

9. A method of forming a notebook having a customized front cover formed from a front chipboard layer, comprising the steps of:
printing a first custom design on a first sheet of pressure sensitive label stock;
applying the printed first sheet of pressure-sensitive label stock to an outer side of the front chipboard layer;
applying a finish to an outer surface of the printed first sheet of pressure-sensitive label stock to produce a finished customized front notebook cover; and
assembling the notebook comprising the finished customized front cover, paper, a rear cover and a binding.

10. The method of claim 9, wherein the finish applied to the outer surface of the printed first sheet of pressure-sensitive label stock is a scuff-free silk finish.

11. The method of claim 9, further comprising the step of applying a finish to the outer side of the front chipboard layer before the printed first sheet of pressure-sensitive label stock is applied thereto.

12. The method of claim 9, further comprising the step of applying a finish to an inner side of the front chipboard layer before the printed first sheet of pressure-sensitive label stock is applied to the outer side of the front chipboard layer.

13. The method of claim 9, wherein the first custom design includes a selected custom design and personalization

14. The method of claim 9, wherein the rear cover is a customized rear cover having a rear chipboard layer formed by the steps of:
printing a second custom design on a second sheet of pressure sensitive label stock;
applying the printed second sheet of pressure-sensitive label stock to an outer side of the rear chipboard layer;
applying a finish to the outer surface of the printed second sheet of pressure-sensitive label stock to produce a finished customized rear notebook cover.

15. The method of claim 14, wherein the finish applied to the outer surface of the printed second sheet of pressure-sensitive label stock is a scuff-free silk finish.

16. The method of claim 14, further comprising the step of applying a finish to the outer side of the rear chipboard layer before the printed second sheet of pressure-sensitive label stock is applied thereto.

17. The method of claim 14, further comprising the step of applying a finish to an inner side of the rear chipboard layer before the printed second sheet of pressure-sensitive label stock is applied to the outer side of the rear chipboard layer.

18. The method of claim 14, wherein the second custom design includes a selected custom design and a logo.
